(19) United States
(12) Patent Application Publication
(10) Pub. No.: US 2013/0228003 A1
(43) Pub. Date: Sep. 5, 2013

(54) Coriolis Mass Flowmeter and Method for Operating a Coriolis Mass Flowmeter

(71) Applicants: Thomas Bierweiler, Stutensee (DE); Martin Borrmann, Karlsruhe (DE); Allan Juhl Kristensen, AM Veldhoven (NL)

(72) Inventors: Thomas Bierweiler, Stutensee (DE); Martin Borrmann, Karlsruhe (DE); Allan Juhl Kristensen, AM Veldhoven (NL)

(73) Assignee: Siemens Aktiengesellschaft, Muenchen (DE)

(21) Appl. No.: 13/813,600

(22) PCT Filed: Aug. 2, 2010
(86) PCT No.: PCT/EP10/61198

§ 371 Date: May 3, 2013

(51) Int. Cl. G01F 25/00

(52) U.S. Cl. CPC G01F 25/0007
USPC 73/1.16

(57) ABSTRACT

A method and Coriolis mass flowmeter, wherein the Coriolis mass flowmeter includes at least one measurement tube through which a medium flows, at least one exciter system arranged in the central region of the at least one measurement tube which causes the measurement tube to oscillate, and at least two oscillation pick-ups arranged in front of and behind the at least one exciter system. The at least two measurement tubes are additionally each provided with at least one acceleration sensor arranged in front and/or behind the exciter system. An evaluation device is configured to receive acceleration signals from the acceleration sensors and evaluate the acceleration signals to diagnose an asymmetry in the measurement tubes such that fault states, such as deposits in one of the two measurement tubes, blockage of a tube in a flow divider or asymmetrical changes in the ability of the measurement tubes to oscillate, such as due to cracks or fractures, can advantageously be detected.

The present invention relates to a Coriolis mass flowmeter and to a method for operating a Coriolis mass flowmeter.

Coriolis mass flowmeters generally have a single measuring tube or a number of measuring tubes, for example a pair, through which there flows a medium (for example fluid), of which the mass flow is to be determined. Various arrangements and geometries of the measuring tubes are known for this.

There are, for example, Coriolis mass flowmeters with a single straight measuring tube and Coriolis mass flowmeters with two curved measuring tubes running parallel to one another. The latter measuring tubes, formed identically as a pair, are induced by an excitation system placed in the middle region to vibrate in such a way that they oscillate in opposition to one another, that is to say the vibrations of the two measuring tubes are phase-offset with respect to one another by 180°, to achieve a mass equalization. The position of the center of mass of the system formed by the two measuring tubes thereby remains substantially constant and forces occurring are largely compensated. As a positive consequence, this has the result that the vibrating system has scarcely any external effect as such. Provided upstream and downstream of the excitation system are vibration pickups, between the output signals of which a phase difference can be evaluated as a measuring signal when there is a flow. This is caused by the Coriolis forces prevailing when there is a flow, and consequently by the mass flow. The density of the medium influences the resonant frequency of the vibrating system. Consequently, apart from the mass flow, it is also possible to determine, inter alia, the density of the flowing medium.

Coriolis mass flowmeters are used in installations for measuring the flow of a wide variety of media. Deposits in the measuring tubes, for example due to limescale, the curing of polymers or the depositing of food residues, influence the measuring accuracy of these meters, both with respect to the measurement of the mass flow and with respect to the determination of the density of the medium. In particular in the case of Coriolis mass flowmeters with at least two measuring tubes, deposits are problematic whenever they are formed asymmetrically, with the result that the flow through the two measuring tubes becomes uneven. As a result, the overall pulse, which in the case of two tubes oscillating symmetrically in opposition to one another is altogether zero in the deposit-free state on account of the mass equalization, is different from zero. If there are asymmetric deposits, the mass flowmeter is consequently more susceptible to react to external vibrations or itself transfers vibrations to the flange-mounted process pipes. A further problem of asymmetric flow is the complete blockage of a measuring tube, for example due to solid constituents such as fruit pips in the medium. As a result, the pressure drop caused by the mass flowmeter increases considerably. Sensitive media, for example jam, may be rendered unusable by the high pressure that occurs in this case.

The invention is consequently based on the object of providing a Coriolis mass flowmeter and a method for operating such a meter that make a self-diagnosis of the mass flowmeter possible on the basis of asymmetric flow and/or other asymmetry errors occurring.

To achieve this object, the novel Coriolis mass flowmeter of the type mentioned at the beginning has the features specified in the characterizing part of claim 1. Advantageous developments are described in the dependent claims and a method for operating a Coriolis mass flowmeter is described in claim 9.

The invention has the advantage that various asymmetry errors of the mass flowmeter that may occur during operation can be detected by self-diagnosis. Examples of such errors are:
deposits in one of the two tubes,
blocking of a tube in the flow divider and
errors based on uneven deposits in the two tubes or
asymmetrical changing of the ability of the tube to oscillate, for example due to a crack or fracture.

The self-diagnosis on the basis of asymmetric flow occurring can consequently provide an operator of the Coriolis mass flowmeter with valuable information about the safety of a process in which the meter is used.

Since the acceleration pickups are attached to the measuring tubes in addition to conventional vibration pickups, the novel approach in this context of functional separation is taken, with the result that optimum components can be used for the respective function. That is to say that the vibration pickups can continue as before to be optimized for the measurement of the phase differences, but the acceleration sensors can be adapted in the best possible way to their task, detecting an asymmetry in the measuring tubes. Tests with a Coriolis mass flowmeter that has only conventional vibration pickups on the basis of magnetic plunger coils have shown that the complete blocking of one of the two measuring tubes by a cork plug in the flow divider leads to relative measuring errors of the mass flow of 2% to 3% with water as the medium. This gives a magnitude of error that is well above the specified measuring error of, for example, 0.15%. However, no significant differences from the undisturbed case can be found in the vibration signals that are obtained in the evaluation device of the meter during measurement, for example, current flow, amplitude or differential signal of the vibration signals. A self-diagnosis of this error case on the basis of the vibration signals of conventional vibration pickups has consequently proven to be scarcely possible. On the other hand, with the novel use of additional acceleration sensors, a self-diagnosis with significantly improved reliability of the diagnosis finding is achieved.

Preferably, acceleration sensors that are made using MEMS technology (MEMS—Micro Electro Mechanical System), or with piezoelectric signal generation, may be used. These can be applied with particularly little effort.

In a particularly advantageous exemplary embodiment, the acceleration sensors are attached at the same location in the longitudinal direction of the at least one measuring tube at which the vibration pickup is also secured. As a result, additional mounting points can be avoided and it is possible to use the same securing means for both components.

If in the case of a symmetrical measuring tube arrangement the acceleration sensors are likewise arranged symmetrically in relation to one another, this has the advantage that the evaluation of the acceleration signals becomes particularly easy, since a logic operation performed on the signals can be reduced to a simple addition or subtraction.

In a further, particularly advantageous refinement of a mass flowmeter with two measuring tubes, two acceleration sensors upstream of the excitation system and two further acceleration sensors downstream of the excitation system are arranged symmetrically in relation to one another. This makes particularly good sensitivity of the arrangement with respect to asymmetry errors possible, and consequently particularly good reliability of the diagnosis finding reached in a self-diagnosis.

In the case of a symmetrical arrangement of acceleration sensors in pairs, the evaluation of the acceleration signals emitted by them can be carried out in a particularly easy way in that the signals are added to form an aggregate signal, the aggregate signal is compared with a predeterminable or predetermined first threshold value and an asymmetry error is indicated by a message signal if the first threshold value is exceeded by the aggregate signal. This evaluation allows an asymmetry to be established in a particularly reliable way. This is so because, in the case of a symmetrical oscillation, each of the acceleration sensors arranged symmetrically in relation to one another in pairs generates a precisely inverted signal of the other sensor respectively belonging to the same pair. If the two signals are added, the resultant aggregate signal therefore has an amplitude that is ideally equal to zero in the error-free case. If deposits that have a density deviating from the flowing medium or change the elastic bending properties of the measuring tube concerned occur in one of the two measuring tubes, this leads to changing of the amplitude of the respective acceleration signal, and consequently to an aggregate signal different from zero. Deposits in one measuring tube or uneven deposits in the two measuring tubes can consequently be established in an easy way by a comparison of the aggregate signal with a threshold value.

To allow for asymmetries specific to a particular meter, which are virtually unavoidable in a Coriolis mass flowmeter after its production, the evaluation device may be provided with a memory in which there is stored a correction value, for the first threshold value or the aggregate signal, determined meter-specifically during a calibration or initial operation of the Coriolis mass flowmeter. This advantageously allows avoidance of an error diagnosis on the basis of asymmetries of the tubes or tolerances of the acceleration sensors or of the evaluation device.

In addition or as an alternative to the addition of the acceleration signals in pairs described above, the respective phase difference of the acceleration signals of the two pairs of acceleration sensors arranged on the same measuring tube upstream and downstream of the excitation system may be determined by the evaluation device. The deviations of the two phase differences are compared with a predeterminable or predetermined second threshold value and an asymmetry error is indicated by a message signal if the second threshold value is exceeded by these deviations. This type of evaluation of the acceleration signals leads to a likewise very high sensitivity, and also makes it possible to establish blocking of a measuring tube in the region of the flow divider, since in this error case there is a great deviation of the two phase differences. If the flow through a pair of measuring tubes is asymmetric, this leads to Coriolis forces that deviate greatly from one another, and the phase difference in the direction of flow caused by the Coriolis force, which is comparatively great, is evaluated in this evaluation.

The invention and also refinements and advantages are explained in more detail below on the basis of the drawings, in which exemplary embodiments of the invention are represented and in which:

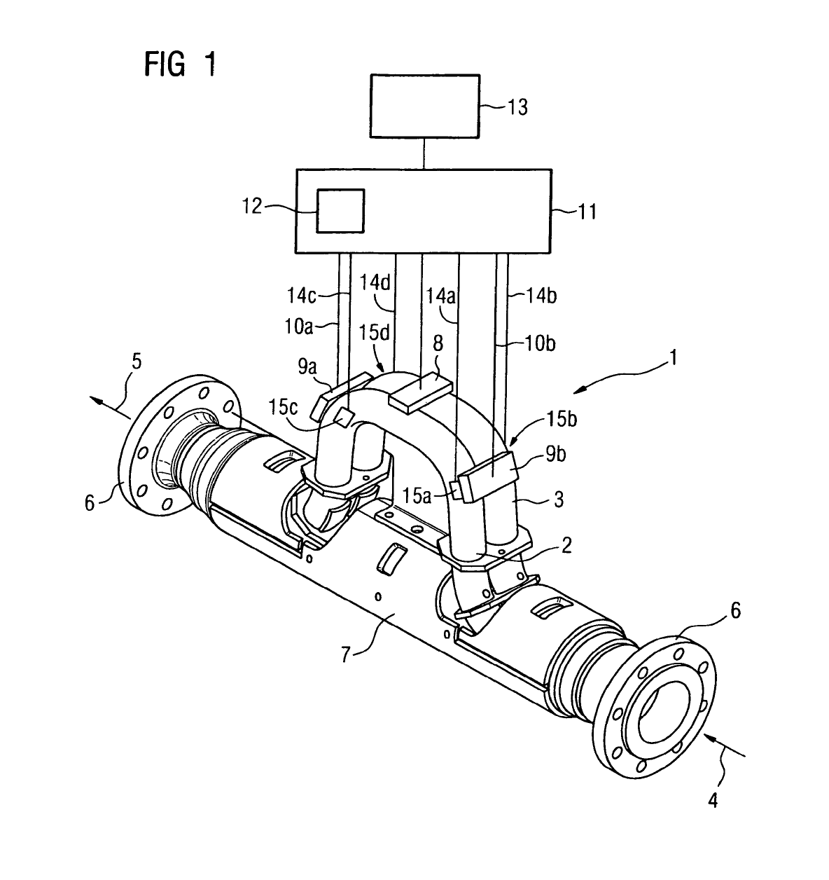

FIG. 1 shows a perspective view of a Coriolis mass flowmeter,

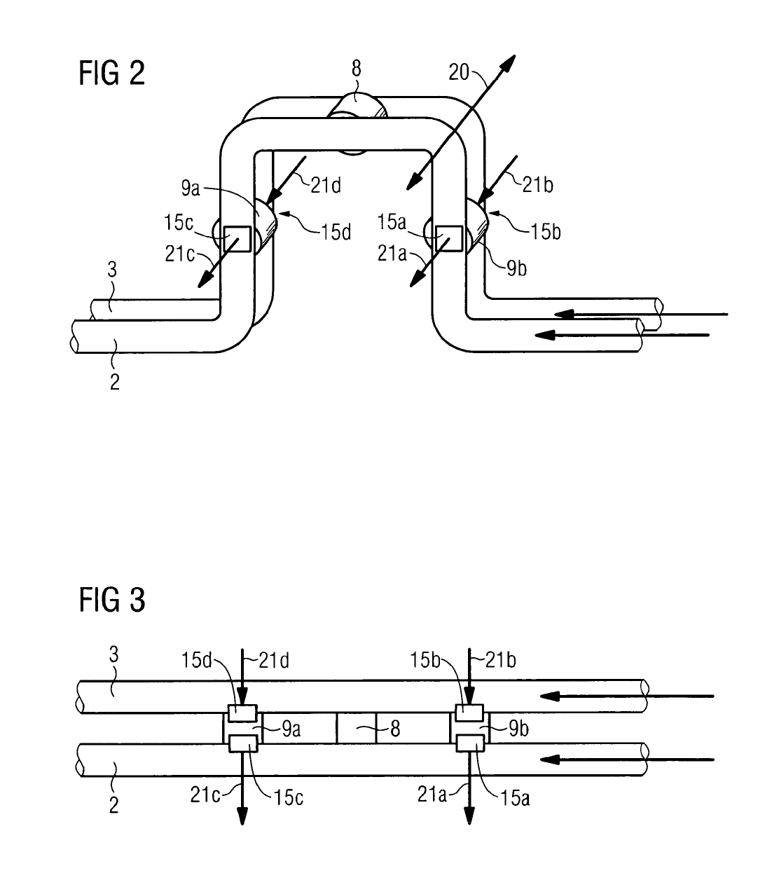

FIG. 2 shows a basic representation of the path followed by a measuring tube,

FIG. 3 shows a further basic representation of a measuring tube in another view,

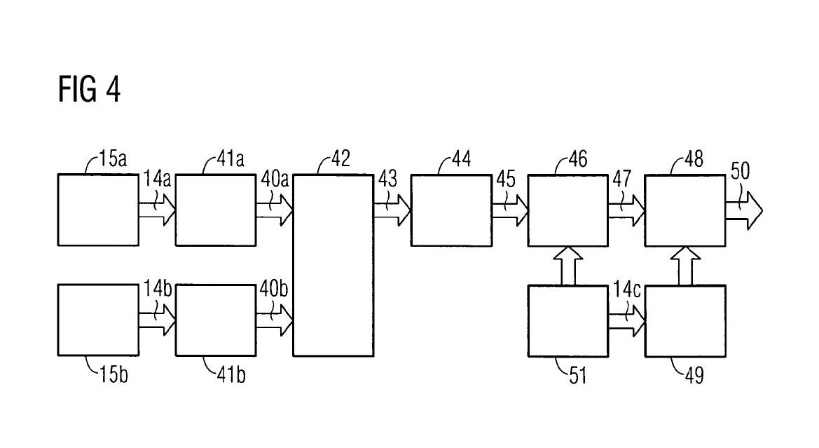

FIG. 4 shows a block diagram to illustrate the signal evaluation in the case of two acceleration sensors,

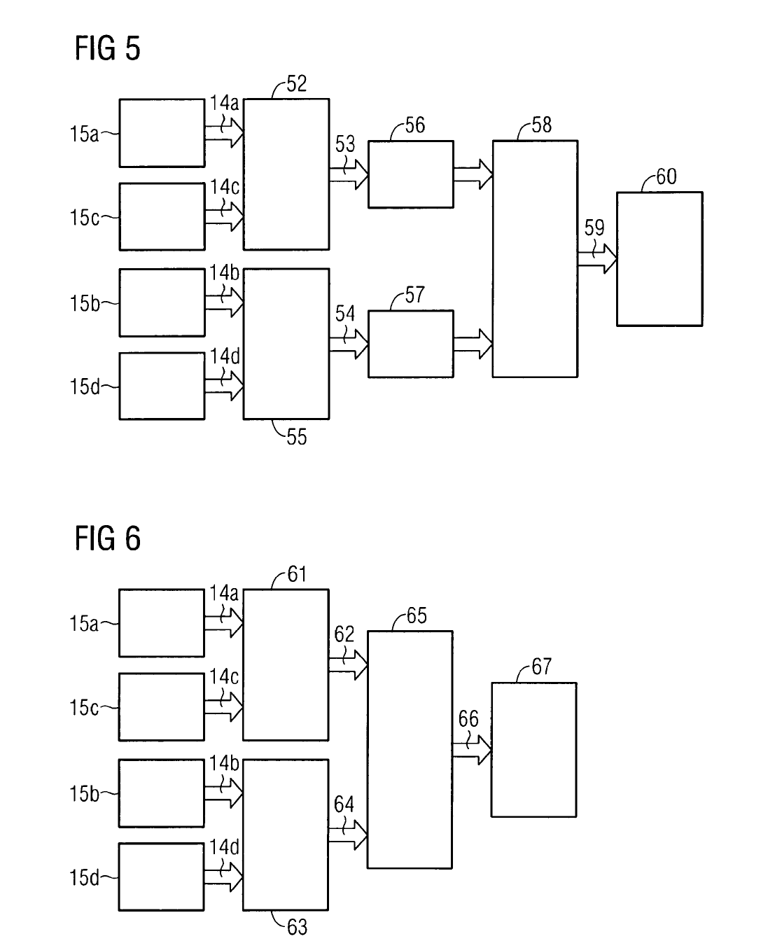

FIG. 5 shows a block diagram to illustrate the signal evaluation in the case of four acceleration sensors and

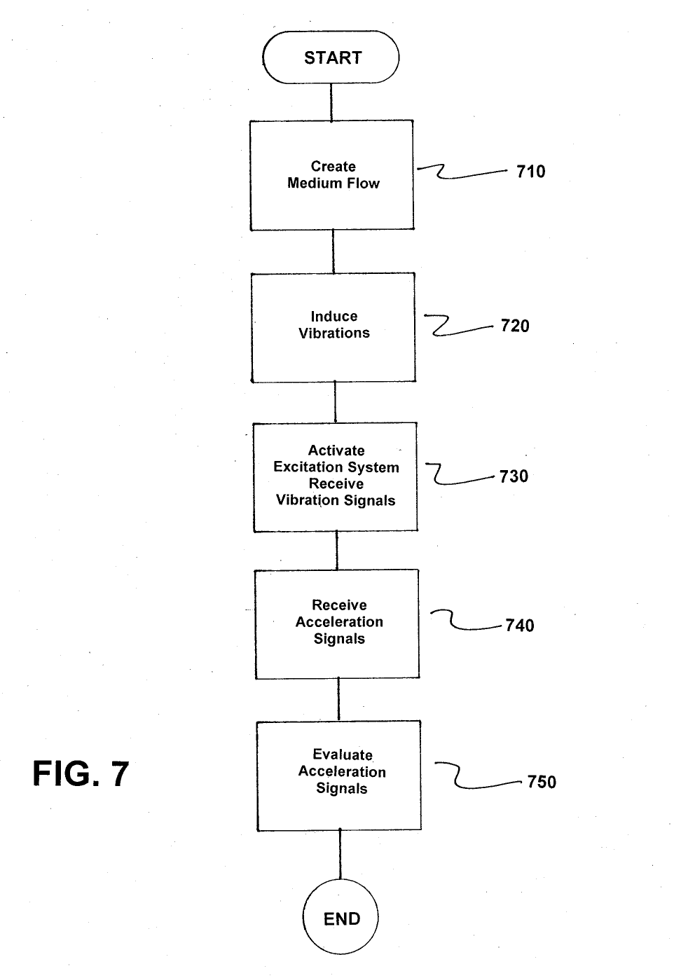

FIG. 6 shows a block diagram to illustrate the signal evaluation in the case of four acceleration sensors and evaluation of the phase differences.

In the figures, the same parts are provided with the same designations.

FIG. 1 shows a Coriolis mass flowmeter 1 according to a preferred exemplary embodiment of the present invention. The mass flowmeter 1 measures the mass flow and the density of the medium on the basis of the Coriolis principle. A first measuring tube 2 and a second measuring tube 3 are arranged substantially parallel to one another. They are usually made from one piece by bending. The path followed by the measuring tubes is substantially U-shaped. A flowable medium flows according to an arrow 4 into the mass flowmeter 1, and thereby into the two inlet portions of the measuring tubes 2 and 3 located downstream of an inlet splitter, which cannot be seen in the figure, and according to an arrow 5 out again from the outlet portions and the outlet splitter located downstream thereof, which likewise cannot be seen in the figure. Flanges 6, which are respectively fixedly connected to the inlet splitter and the outlet splitter, serve for securing the mass flowmeter 1 in a pipeline not represented in FIG. 1. The geometry of the measuring tubes 2 and 3 is kept largely constant by a stiffening frame 7, so that even changes of the pipeline system in which the mass flowmeter is fitted, for example caused by temperature fluctuations, lead at most to a minor shift of the zero point. An excitation system 8, which is schematically represented in FIG. 1 and may comprise, for example, a magnetic coil that is secured on the measuring tube 2 and a magnet that is attached to the measuring tube 3 and plunges into the magnetic coil, serves for generating mutually opposed vibrations of the two measuring tubes 2 and 3, the frequency of which corresponds to the natural frequency of the substantially U-shaped middle portions of the measuring tubes 2 and 3.

Vibration pickups 9a and 9b that are likewise schematically represented in FIG. 1 serve for sensing the Coriolis forces and/or the vibrations of the measuring tubes 2 and 3 that are based on the Coriolis forces and are caused by the mass of the medium flowing through. They are likewise embodied as plunger coils. Vibration signals 10a and 10b, which are generated by the vibration pickups 9a and 9b, respectively, are evaluated by an evaluation device 11. For the evaluation, the evaluation device 11 comprises a digital signal processor, which carries out the necessary calculation steps. Results of the evaluation, in particular measured values for the mass flow and density and also diagnosis messages, are output on a display 13 or transmitted via an output not represented in the figure, for example a fieldbus, to a higher-level control station. Apart from the evaluation of the vibration signals 10a, 10b, the evaluation device 11 in the exemplary embodiment represented also undertakes the activation of the excitation system 8 as well as the carrying out of the evaluations for a self-diagnosis of the Coriolis mass flowmeter 1. The self-diagnosis is performed on the basis of four acceleration signals 14a, 14b, 14c and 14d, which are supplied by four acceleration sensors, of which only acceleration sensors 15a and 15c can be seen in FIG. 1. Two acceleration sensors 15b and 15d are located on the remote side of the measuring tube 3 and consequently cannot be seen in FIG. 1.

As a departure from the exemplary embodiment represented, it goes without saying that the measuring tubes may have different geometries, for example a V-shaped or a-shaped middle portion, or a different number and arrangement of excitation systems, vibration pickups and/or acceleration sensors may be chosen. The Coriolis mass flowmeter may alternatively have a different number of meaning tubes, for example one measuring tube or more than two measuring tubes.

In a memory 12 of the evaluation device 11, parameters determined during the calibration of the Coriolis mass flowmeter 1 are stored, for example a correction value that has been determined meter-specifically and serves for the adaptation of a first and a second threshold value, which are used in the self-diagnosis for deriving a diagnosis finding.

The way in which the acceleration sensors are applied in principle to the measuring tubes is explained once again on the basis of FIGS. 2 and 3. In this respect, it is unimportant whether the acceleration sensors 15a . . . 15d are applied on the outer side of the measuring tubes, as shown in FIG. 2, or on the sides facing one another of the measuring tubes 2 and 3, as represented in FIG. 3. By contrast, it is of importance for the logic operation that is used in the evaluation of the acceleration signals that the acceleration sensors 15a . . . 15d are sensitive in the same direction. This is achieved by suitable selection of the type of acceleration sensors and by a suitable application to the measuring tubes 2 and 3. In a particularly advantageous refinement, the acceleration sensors respectively have a preferential direction of their sensitivity, which is aligned parallel to the oscillating direction of the measuring tubes 2 and 3. In FIG. 2, the oscillating direction of the measuring tubes is represented by an arrow 20. Suitable preferential directions of the sensitivities of the acceleration sensors 15a . . . 15d are marked correspondingly by arrows 21a, 21b, 21c and 21d, respectively. The acceleration respectively measured by the acceleration sensors 15a . . . 15d may be regarded as a directional vector. If the acceleration sensors are applied with a sensitivity direction deviating from the exemplary embodiment represented, it goes without saying that the logic operation in the evaluation must be correspondingly adapted. If, for example, the acceleration sensor 15b has its direction of sensitivity opposite to that of acceleration sensor 15a, the addition of the acceleration signals 14a and 14b carried out in the evaluation (FIG. 1) is replaced by a subtraction. The vibration pickups 9a and 9b are embodied like the excitation system 8 as plunger coils. The measuring tubes 2 and 3 are induced by the excitation system 8 to vibrate with oscillations in phase opposition. The two vibration pickups 9a and 9b are arranged symmetrically in relation to the middle of the measuring tubes 2 and 3, consequently at the same distance from the excitation system 8. The sampling frequency with which vibration signals 10a and 10b supplied by the vibration pickups 9a and 9b are sampled (FIG. 1) in this case usually lies approximately at a frequency 15 times higher than the excitation frequency of the excitation system 8. Plunger coils, which as vibration pickups 9a and 9b make a very exact detection of the phase difference possible, are however scarcely suitable for detecting an asymmetric flow, since they pick up the relative movement of the two measuring tubes 2 and 3 in relation to one another. For better detection of an asymmetry, and consequently to improve the reliability of diagnosis findings in this respect, acceleration sensors 15c and 15d and also 15a and 15b are respectively applied in addition to the vibration pickups 9a and 9b at the same level in the longitudinal direction of the measuring tubes 2 and 3. Therefore, the same securing means as are also used for the attachment of the vibration pickups 9a and 9b may serve for the application of the acceleration sensors 15a . . . 15d. The acceleration sensors may, for example, be secured directly to the plunger coils. As a result, additional mounting points on the measuring tubes 2 and 3 can be avoided. In principle, although a pair of acceleration sensors, for example the acceleration sensors 15a and 15b, would be sufficient for the detection, the sensitivity can be improved significantly by the use of two pairs.

When mounting the acceleration sensors 15a . . . 15d, allowance must be made for them having a preferred measuring direction if they are for example made piezoelectrically or using MEMS technology. If the measuring directions of the acceleration sensors 15a . . . 15d are chosen as represented in FIGS. 2 and 3, when there is symmetrical deflection of the two measuring tubes 2 and 3 the acceleration sensor 15a supplies an acceleration signal that corresponds approximately to the inverted acceleration signal of the acceleration sensor 15b. This applies correspondingly to the acceleration signals that are output by the acceleration sensors 15c and 15d. However, this no longer applies if, due to an error state, for example due to deposits in one of the two measuring tubes 2 or 3, an asymmetry has occurred. If, for example, there occur in the measuring tube 2 deposits that are larger than the deposits occurring in the measuring tube 3, the measuring tube 2 oscillates with a small amplitude and the acceleration sensors 15a and 15c supply acceleration signals of amplitudes that are consequently likewise smaller than the amplitudes of the acceleration signals supplied by the acceleration sensors 15b and 15d.

This is used in the evaluation explained below on the basis of FIG. 4. The two acceleration sensors 15a and 15b supply acceleration signals 14a and 14b, respectively, to the evaluation device (11 in FIG. 1). There, the two acceleration signals 14a and 14b are initially subjected to a bandpass filtering, in which the signal components 40a and 40b of the fundamental oscillation of the measuring tubes are allowed to pass through. This takes place by means of two bandpass filters 41a and 41b. The bandpass filtering has the effect of removing disturbing frequency components from the acceleration signals 14a and 14b. This is optional and in an alternative embodiment may possibly be omitted. The signal components 40a and 40b are fed to an adder 42, which calculates from them an aggregate signal 43. In the case of an ideal symmetry of the measuring tubes, the aggregate signal 43 would be equal to zero, as already explained above. On the basis of the size of the aggregate signal 43, an asymmetry error of the measuring tubes can therefore be detected in an easy way. In the exemplary embodiment represented, the aggregate signal 43 is passed for evaluation to an amplitude detector 44, the output signal 45 of which is subjected to a subsequent normalizing operation in a functional block 46. A normalized signal 47 obtained in this way is assessed in a functional block 48 by comparison with a first threshold value 49. If it is greater than the threshold value 49, the error state of an asymmetry that is present is output by means of a display signal 50. For signal conditioning, as an alternative to the amplitude detector 44 and the normalizing operation in the functional block 46, a rectification of the aggregate signal 43 with subsequent lowpass filtering is similarly possible. The determination of an assessment factor for the amplitude or the energy of the aggregate signal 43 can consequently be carried out in various ways. According to a functional block 51, a correction of the first threshold value 49 or of the assessment factor may be additionally performed. Consequently, an adaptation to the respective meter- or application-specific conditions is possible during the calibration of the mass flowmeter or during its initial operation. This has the advantage that allowance can be made in the determination of the diagnosis finding for possible production-related asymmetries of the measuring tubes or tolerances of the acceleration sensors or variations in the measured value processing of the evaluation device. In the case of a perfectly symmetrical flow through the two measuring tubes, the aggregate signal 43 has the value zero. If the first threshold value 49 is exceeded by the normalized amplitude 47, there is an asymmetry of the measuring tubes. This is reliably diagnosed and indicated by the method or by the novel Coriolis mass flowmeter.

The diagnosis described on the basis of FIG. 4 is based on the evaluation of the signals of two acceleration sensors arranged symmetrically in relation to one another. However, the sensitivity can be increased if instead four acceleration sensors are used.

FIG. 5 shows a diagnosis method in which the acceleration signals 14a and 14c of the acceleration sensors 15a and 15c, respectively, are combined by a logic operation with the aid of a subtractor 52 to form a differential signal 53. A second differential signal 54 is calculated with the aid of a second subtractor 55 on the basis of the acceleration signals 14b and 14d of the acceleration sensors 15b and 15d, respectively. Obtained as a result are differential signals 53 and 54, which have been freed of an acceleration component that would be obtained in a mass flow measurement without any flow. The two differential signals 53 and 54 are respectively conditioned by amplifiers 56 and 57 and a renewed calculation is subsequently carried out with the aid of a further subtractor 58 to give a differential signal 59, which in a functional block 60 is subjected to an evaluation that corresponds in principle to that already described further above on the basis of the functional blocks 44 . . . 51 in FIG. 4. Consequently, an asymmetric flow in the measuring tubes 2 and 3 can be detected with good sensitivity. This is so because a strong asymmetry of the flow through the two measuring tubes leads to a corresponding increase in the energy of the differential signal 59.

In the case of the exemplary embodiments of a diagnosis method shown in FIG. 6, the phase difference 62 between the vibration signals 14a and 14c for the vibration sensors 15a and 15c, respectively, is calculated in a functional block 61 and the phase difference 64 between the acceleration signals 14b and 14d of the acceleration signals 15b and 15d, respectively, is calculated in a functional block 63. The phase differences 62 and 64 are measures of the respective mass flow through the measuring tubes 2 and 3. In a downstream functional block 65, the difference 66 of the phase differences 62 and 64 is calculated. The difference 66 in turn represents an assessment factor for the obtainment of a diagnosis finding as to the presence of an asymmetry and is evaluated in a functional block 67 in a way that has already been described in principle on the basis of the functional blocks 44 . . . 51 in FIG. 4. That is to say that the difference 66 may be subjected to a normalizing operation and allowance can be made for production-related asymmetries by means of a correction factor. This is followed by a comparison with a threshold value. If the threshold value is exceeded, there is an inadmissible asymmetry of the measuring tubes and it is indicated. The evaluation of the phase differences described on the basis of FIG. 6 when using four acceleration sensors has the advantage that it is distinguished by particularly good sensitivity. Both measuring tubes are driven at their resonant frequency by the excitation system, with the result that the fundamental oscillation for both measuring tubes is in phase opposition with the same amplitude. The Coriolis force is generated in both measuring tubes by the flow respectively prevailing. If the flow is in this case asymmetric, the Coriolis force in the two measuring tubes also differs in its intensity. If only two acceleration sensors are used, as explained on the basis of FIG. 4, the difference of the acceleration signals can already be evaluated. Since, however, the Coriolis force occurring is comparatively small, the difference of the two acceleration signals is likewise small. If, as described on the basis of FIG. 6, acceleration signals of four acceleration sensors are used, the phase difference in the direction of flow that is caused by the Coriolis force and is greater by a multiple can be evaluated.

In FIGS. 4 to 6, the respectively different diagnosis methods are illustrated. Input signals are always acceleration signals, which in an actual implementation of the mass flowmeter are obtained by sampling the analog output signals of acceleration sensors. The various steps of the evaluation are actually implemented in the firmware of a signal processing processor or of a microcontroller. It goes without saying that, as an alternative to this, parts of the signal processing, for example the bandpass filtering or the addition, may be actually implemented before the sampling by an analog hardware circuit. This type of implementation has the advantage over purely digital measured-value processing that the required sampling rate and the required computing power are lower.

1.-9. (canceled)

10. A Coriolis mass flowmeter comprising:
at least one measuring tube through which a medium flows;
at least one excitation system arranged in a middle region of the at least one measuring tube and configured to induce vibration of the at least one measuring tube;
at least two vibration pickups arranged upstream and downstream of the at least one excitation system in a longitudinal direction of the at least one measuring tube; and
an evaluation device configured to activate the at least one excitation system, receive vibration signals from the at least two vibration pickups and evaluate the at least two vibration pickups to determine a measured value for a mass flow;
wherein the at least two measuring tubes are additionally respectively provided with at least one acceleration sensor arranged at least one of upstream and downstream of the at least one excitation system in the longitudinal direction of the at least one measuring tube; and
wherein the evaluation device is further configured to receive acceleration signals from the acceleration sensors and evaluate the received acceleration signals for diagnosis of an asymmetry of the at least two measuring tubes.

11. The Coriolis mass flowmeter as claimed in claim 10, wherein the at least one acceleration sensor is made at least one of piezoelectrically and using Micro Electro Mechanical System (MEMS) technology.

12. The Coriolis mass flowmeter as claimed in claim 10, wherein the at least one acceleration sensor is attached at a vibration pickup of the at least two vibration pickups in the longitudinal direction of the at least one measuring tube.

13. The Coriolis mass flowmeter as claimed in claim 11, wherein the at least one acceleration sensor is attached at a vibration pickup of the at least two vibration pickups in the longitudinal direction of the at least one measuring tube.

14. The Coriolis mass flowmeter as claimed in claim 12, wherein, in a case of a symmetrical measuring tube arrangement, at least one pair of acceleration sensors is likewise arranged symmetrically in relation to one another.

15. The Coriolis mass flowmeter as claimed in claim 14, wherein two measuring tubes are provided, and wherein two acceleration sensors are arranged upstream of the at least one excitation system in the longitudinal direction of the two measuring tubes and two further acceleration sensors are arranged downstream of the excitation system.

16. The Coriolis mass flowmeter as claimed in claim 14, wherein the evaluation device is further configured to add the received acceleration signals of at least one pair of acceleration sensors arranged symmetrically in relation to one another to form an aggregate signal, compare the aggregate signal with one of a predeterminable and predetermined first threshold value and indicate a symmetry error by a message signal if a first threshold value is exceeded.

17. The Coriolis mass flowmeter as claimed in claim 15, wherein the evaluation device is further configured to add the received acceleration signals of at least one pair of acceleration sensors arranged symmetrically in relation to one another to form an aggregate signal, compare the aggregate signal with one of a predeterminable and predetermined first threshold value and indicate a symmetry error by a message signal if a first threshold value is exceeded.

18. The Coriolis mass flowmeter as claimed in claim 16, wherein the evaluation device includes a memory in which a correction value is stored for the first threshold value which determined meter-specifically during a one of calibration and initial operation of the Coriolis mass flowmeter.

19. The Coriolis mass flowmeter as claimed in claim 15, wherein the evaluation device is further configured to determine a respective phase difference of the received acceleration signals of the two pairs of acceleration sensors arranged on a same measuring tube upstream and downstream of the at least one excitation system, compare deviations of two phase differences with one of a predeterminable and predetermined second threshold value and indicate an asymmetry error by a message signal if a second threshold value is exceeded.

20. A method for operating a Coriolis mass flowmeter, the method comprising the steps of:
flowing a medium through at least one measuring tube;
inducing vibrations in the at least one measuring tube with at least one excitation system arranged in a middle region of the at least one measuring tube, at least two vibration pickups being arranged upstream and downstream of the at least one excitation system in a longitudinal direction of the at least one measuring tube;
activating, by an evaluation device, the at least one excitation system and receiving vibration signals from the at least two vibration pickups and evaluating the received vibration signals to determine a measured value for a mass flow;
receiving, by the evaluation device, acceleration signals from acceleration sensors, arranged at least one of upstream and downstream of the at least one excitation system in the longitudinal direction of the at least one measuring tube, and
evaluating, by the evaluation device, the acceleration signals for diagnosis of an asymmetry of the measuring tubes.
